(19) United States
(12) Patent Application Publication
(10) Pub. No.: US 2002/0039202 A1
(43) Pub. Date: Apr. 4, 2002

(54) Image processor

(75) Inventors: Hiroki Hachiyama, Kyoto (JP); Kenji Takahashi, Shiga (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 09/963,551

(22) Filed: Sep. 27, 2001

(30) Foreign Application Priority Data
Sep. 29, 2000 (JP) 2000-298079

(51) Int. Cl. H04N 1/387

(52) U.S. Cl. 358/450

(57) ABSTRACT

An image processor includes imager, compressor/expander, image memory, display memory, display and interface. Image data, representing an image captured by the imager, is input to the compressor/expander, which either compresses the image data and outputs the compressed data to the image memory or receives and expands the compressed data and outputs the expanded data to the display memory. The expanded data is then presented on the display. The compressed data is then recorded by the interface on a storage medium. If the imager has captured a series of images consecutively, the image memory stores compressed data representing those images. The compressor/expander expands the compressed data and then outputs the expanded data to the display memory so that the images are presented on the display sequentially in an order in which the images have been captured, while the compressed data is being transferred from the image memory to the storage medium.

### BACKGROUND OF THE INVENTION

The present invention relates to an image processor for capturing an image of an object and then recording image data, representing the image, on a storage medium.

In capturing a series of still images (which operation will be herein referred to as “continuous shooting”), a known image processor compresses the image data representing the series of images captured and then stores the compressed data on an image memory. The processor once stores the compressed data on the image memory to capture those images at as short intervals as possible. On finishing the continuous shooting operation, the image processor starts to transfer the compressed data from the image memory to a storage medium.

FIG. 7 is a block diagram illustrating a configuration for a known image processor of that type. As shown in FIG. 7, the processor includes imager 91, compressor/expander 92, image memory 93, memory interface (I/F) 94, display memory 95, display 96, controller 97 and storage medium 98. In this processor, the image data, captured by an imaging device (not shown) included in the imager 91, is compressed by the compressor/expander 92 and the compressed data is output to, and once stored on, the image memory 93. Then, the image data that has been once stored on the image memory 93 is transferred to the storage medium 98 by way of the memory I/F 94. This data flow is indicated by “A” in FIG. 7. While the data is being transferred to the storage medium 98, the display 96 can operate in monitor display mode, freeze display mode or blackout display mode.

In the monitor display mode, the image to be monitored, which has been output from the imager 91 and just arrived at the display 96, is presented as it is on the display 96. This data flow is indicated by “C” in FIG. 7. In the freeze display mode on the other hand, the image data, which is left on the image memory 95, is presented on the display 96. This data flow is indicated by “D” in FIG. 7. In the blackout display mode, the data that has been provided from the display memory 95 is replaced with data representing the color black and then the blackout data is presented on the display 96. This data flow is also indicated by “D” in FIG. 7.

Where consecutive shots should be reviewed, reproduction processing is started after the image data has been transferred to the storage medium 98 completely. That is to say, the image data should be read out from the storage medium 98 and then decompressed by the compressor/expander 92 before the decompressed data is presented on the display 96. This data flow is indicated by “E” in FIG. 7. In this processor, the overall data transfer is under the control of the controller 97.

In capturing only one image (which operation will be herein referred to as “single shooting”), it takes just a short time for the image processor to transfer the captured image data to the storage medium completely. Accordingly, the time for getting the image processor ready for the next photographing operation is too short to irritate the user. After a series of images have been captured consecutively, however, multiple frames of image data should be once stored on the image memory and then transferred to the storage medium one after another. Thus, the user has to wait a much longer time until the transfer is complete, i.e., before he or she can review the images photographed or can start the next photographing operation.

As can be seen, when using the known image processor, the user has to wait a long time before he or she can review his or her consecutive shots. This is because the image processor should once record the image data on the storage medium and then read out and present the data once stored.

Recently, as the number of imaging devices integrated has been increasing steeply, an even more enormous quantity of data should be transferred from the image memory to the storage medium as for the continuous shooting. Accordingly, the user has to wait a longer and longer time before he or she can review his or her consecutive shots.

Also, in the known image processor, a blackout image or a frozen still image is displayed while the image data is being transferred to the storage medium. This is a bore for almost all users. In addition, even if the display is operated in the monitor display mode, additional power is needed for driving the imager.

### SUMMARY OF THE INVENTION

It is therefore an object of the present invention to provide an image processor allowing the user to review his/her consecutive shots instantaneously, or without making him or her wait a long time until the image data, representing those shots, has been transferred to the storage medium completely.

An image processor according to the present invention is for use to capture an image of an object and record image data, representing the image, on a storage medium. While image data, representing a series of images captured consecutively, is being transferred to the storage medium, the image processor presents the series of images sequentially in an order in which the images have been captured.

According to the present invention, the user can review his or her consecutive shots instantaneously without waiting until the image data, representing his or her shots, has been transferred to the storage medium completely. Thus, while the image data is being transferred, the user can determine whether or not the transfer of the image data should be stopped.

Another image processor according to the present invention includes imager, compressor/expander, image memory, display memory, display and interface. The imager captures an image of an object and outputs image data, representing the image captured, to the compressor/expander. The compressor/expander either compresses the image data and then outputs the compressed image data to the image memory or receives and expands the compressed image data and then outputs the expanded image data to the display memory. The expanded image data, stored on the display memory, is then presented on the display, while the compressed image data, once stored on the image memory, is then recorded by the interface on a storage medium. In this processor, if the imager has captured a series of images consecutively, the image memory stores thereon compressed image data representing the images. On the other hand, the compressor/expander expands the compressed image data, representing those images, and then outputs the expanded image data to the display memory so that the images are presented on the display sequentially in an order in which the images have been captured, while the compressed image data, representing the images, is being transferred from the image memory to the storage medium.

According to the present invention, the user can review his or her consecutive shots instantaneously by reference to the image data being transferred to the storage medium, i.e., without waiting until the image data, representing those shots, has been transferred to the storage medium completely. Thus, while the image data is being transferred, the user can determine whether or not the transfer of the image data should be stopped. In addition, the user can also check any change occurring in the images by comparing one of the consecutive shots to preceding and succeeding ones of the shots.

In one embodiment of the present invention, the compressor/expander may produce a reduced-size image for each said image captured and compress the reduced-size image to obtain and output the compressed image data. The compressor/expander may also expand the compressed image data, representing the series of images, and then output the expanded image data to the display memory so that the reduced-size versions of the series of images can be presented one by one on the same display in the order in which the images have been captured. Then, multiple images of a reduced size can be presented one by one on the same display screen. Accordingly, the user can easily check any change occurring in the images by comparing one of his or her consecutive shots to preceding and succeeding ones of the shots.

In another embodiment, the compressor/expander may expand the compressed image data, representing each of the series of images which is being transferred to the storage medium, and then output the expanded image data to the display memory so that each said image being transferred can be presented on the display. In such an embodiment, each image being transferred can be presented on the display one after another and the user can see how much image data has been transferred so far.

### BRIEF DESCRIPTION OF THE DRAWINGS

FIG. 1 is a block diagram illustrating a configuration for an image processor according to an embodiment of the present invention.

FIG. 2 illustrates the contents stored on the image memory shown in FIG. 1.

FIG. 3 is a timing diagram illustrating how the processor shown in FIG. 1 may operate when presenting thumbnail images.

FIG. 4 illustrates how thumbnail images are presented one by one on the display shown in FIG. 1.

FIG. 5 is a timing diagram illustrating how the processor shown in FIG. 1 may operate when presenting full-size images.

FIG. 6 illustrates how full-size images are presented one after another on the display shown in FIG. 1.

FIG. 7 is a block diagram illustrating a configuration for a known image processor.

### DESCRIPTION OF THE PREFERRED EMBODIMENTS

Hereinafter, preferred embodiments of the present invention will be described with reference to the accompanying drawings.

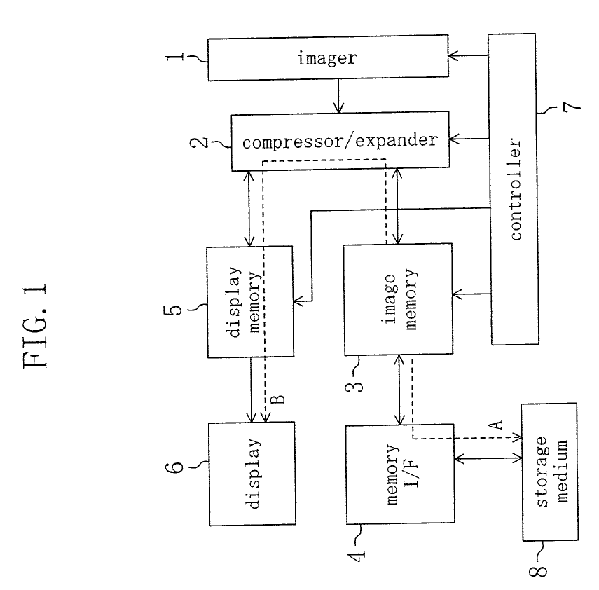

FIG. 1 is a block diagram illustrating a configuration for an image processor according to an embodiment of the present invention. The processor shown in FIG. 1 includes imager 1, compressor/expander 2, image memory 3, memory interface (I/F) 4, display memory 5, display 6 and controller 7. In FIG. 1, the dashed lines indicate two possible data flows A and B.

The imager 1 includes solid-state imaging devices like charge-coupled devices (CCDs) and generates a video signal representing an image captured. Then, the imager 1 converts the video signal into luminance and chrominance signal data and then outputs the data to the compressor/expander 2. An image as represented by the luminance and chrominance signal data will be herein referred to as a “full-size image”.

The compressor/expander 2 decimates pixels from the full-size image output from the imager 1, thereby producing a reduced-size image (which will be herein referred to as a “thumbnail image”). The compressor/expander 2 compresses the full-size or thumbnail image in compliance with the JPEG (joint photographic image coding experts group) standard and then outputs the resultant compressed image data to the image memory 3. Or the compressor/expander 2 reads out the compressed image data from the image memory 3, expands the image data to obtain a full-size or thumbnail image and then outputs the image to the display memory 5.

The image memory 3 temporarily stores thereon the compressed image data of a full-size image (which will be herein referred to as “full-size compressed image data”) and the compressed image data of a thumbnail image (which will be herein referred to as “thumbnail compressed image data”). Then, the image memory 3 writes or reads the compressed image data on/from a storage medium 8 by way of the memory interface 4.

Any type of storage medium that can retain image data thereon may be used as the storage medium 8. Examples of the storage media include semiconductor memories, magnetic recording media and optical disks. The storage medium 8 may be either removable or fixed. In the illustrated embodiment, the storage medium 8 is supposed to be a compact flash card including flash memories. The storage medium 8 may also be a smart medium or a super disk, for example.

The memory interface 4 converts the compressed image data into a version adaptable to the storage medium 8 and then writes the converted data on the storage medium 8. Or the memory interface 4 reads out data from the medium 8, converts the data to obtain compressed image data and then outputs the image data to the image memory 3. For example, where a disk is used as the medium 8, the memory interface 4 may be replaced with a disk drive (not shown) suitable for the disk.

The display memory 5 operates as a display buffer memory. Specifically, the display memory 5 stores the image, which has been expanded and output by the compressor/expander 2, and then outputs the image to the display 6. In response, the display 6 presents the image stored on the display memory 5.

The controller 7 controls the operations of the imager 1, compressor/expander 2, image memory 3 and display memory 5. Specifically, when an appropriate instruction is given to the controller 7, the compressor/expander 2 can selectively read out the compressed image data representing a full-size or thumbnail image from the image memory 3, expand the compressed image data and then get the decompressed image presented on the display 6.

Next, it will be described how the processor shown in FIG. 1 operates during and after continuous shooting.

Where the processor processes a series of images consecutively, the compressor/expander 2 may produce thumbnail images from the output data of the imager 1, which represents full-size images, at regular intervals, compress these images and then output the compressed image data to the image memory 3.

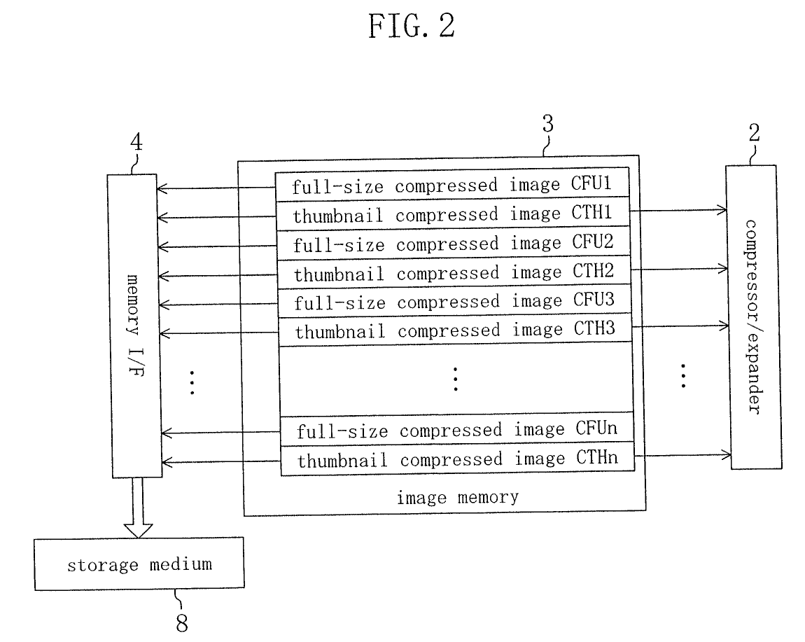

FIG. 2 illustrates the contents stored on the image memory 3. If the imager 1 has captured a number n (which is an integer equal to or greater than two) of images consecutively, the image memory 3 stores first through n^{th} pairs of full-size and thumbnail compressed image data CFU1 and CTH1 through CFUn and CTHn as shown in FIG. 2.

The image memory 3 outputs the full-size compressed image data CFU1 through CFUn and the thumbnail compressed image data CTH1 through CTHn to the memory interface 4. However, the image memory 3 selectively outputs either the full-size compressed image data CFU1 through CFUn or the thumbnail compressed image data CTH1 through CTHn to the compressor/expander 2 in accordance with the type of the images to be presented on the display 6.

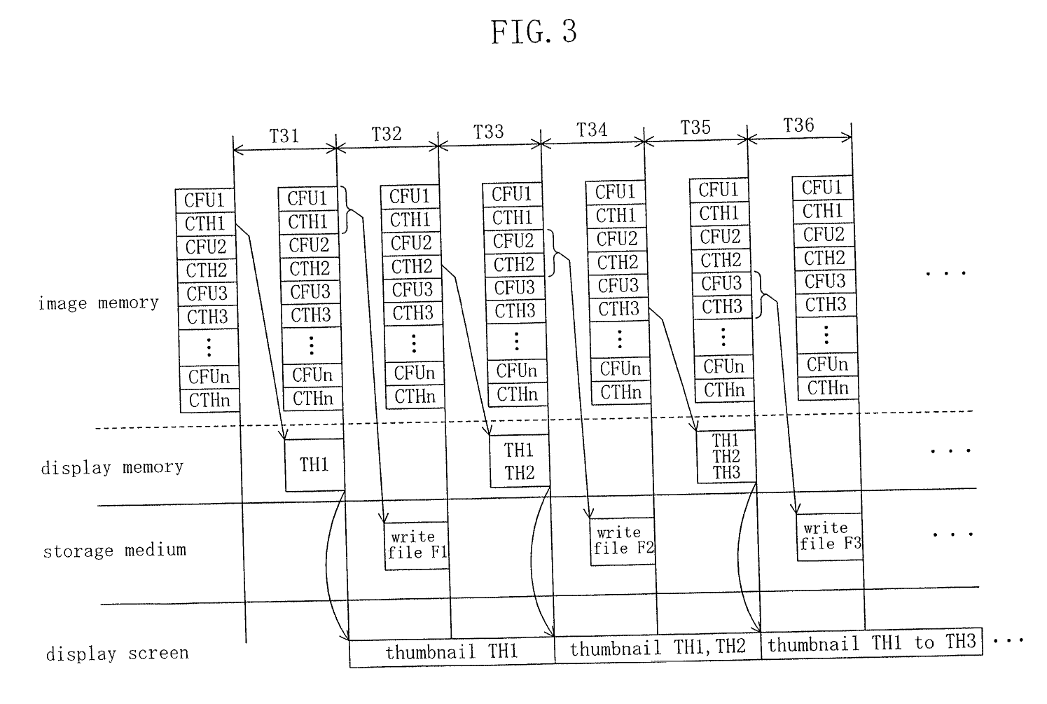

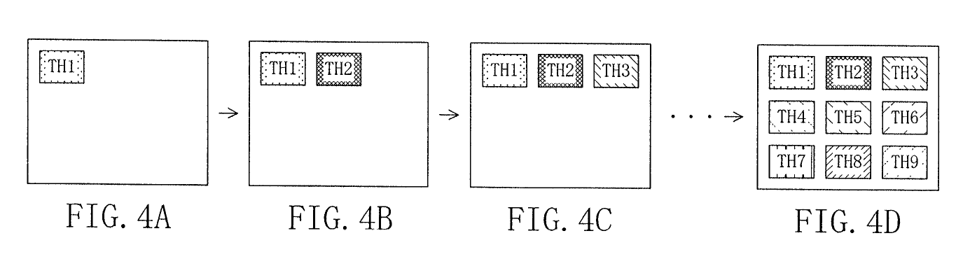

FIG. 3 is a timing diagram illustrating how the processor shown in FIG. 1 may operate when presenting thumbnail images. FIG. 4 illustrates how the thumbnail images are presented one by one on the display 6.

As shown in FIG. 3, in the interval T31 just after the images have been captured consecutively, the compressor/expander 2 reads out only the thumbnail compressed image data CTH1 of the first image from the image memory 3, expands the image data CTH1 to obtain a thumbnail image TH1 and then outputs the image TH1 to the display memory 5. This data flow is indicated by “B” in FIG. 1.

In the next interval T32, the image memory 3 transfers the full-size and thumbnail compressed image data CFU1 and CTH1 of the first image to the storage medium 8 by way of the memory interface 4. As a result, these two types of data are written as a file F1 on the storage medium 8. This data flow is indicated by “A” in FIG. 1. In the meantime, the display 6 presents the thumbnail image TH1 of the first image that has been stored on the display memory 5 as shown in FIG. 4A. This data flow is indicated by “B” in FIG. 1. That is to say, the image being transferred to the storage medium 8 is presented on the display 6.

In the next interval T33, the same thumbnail image TH1 is still presented on the display 6. In this same interval, the compressor/expander 2 reads out only the thumbnail compressed image data CTH2 of the second image from the image memory 3, expands the image data CTH2 to obtain a thumbnail image TH2 and then outputs the image TH2 to the display memory 5. In this case, the controller 7 controls the addresses of the images TH1 and TH2 on the display memory 5 so that the thumbnail image TH2 does not overlap with, but is displayed next to, the thumbnail image TH1.

In the next interval T34, the image memory 3 transfers the full-size and thumbnail compressed image data CFU2 and CTH2 of the second image to the storage medium 8 by way of the memory interface 4. As a result, these two types of data are written as a file F2 on the storage medium 8. In the meantime, the display 6 presents, side by side, the thumbnail images TH1 and TH2 of the first and second images stored on the image memory 5 as shown in FIG. 4B.

In the same way, after the thumbnail image TH3 of the third image has been output to the display memory 5 in the interval T35, the compressed image data of the third image is transferred from the image memory 3 to the storage medium 8 and written as a file F3 on the medium 8 in the interval T36. In this interval T36, the thumbnail images TH1 through TH3 are presented on the display 6 as shown in FIG. 4C. These operations will be repeatedly performed until the compressed image data of the n^{th} image has been written on the medium 8.

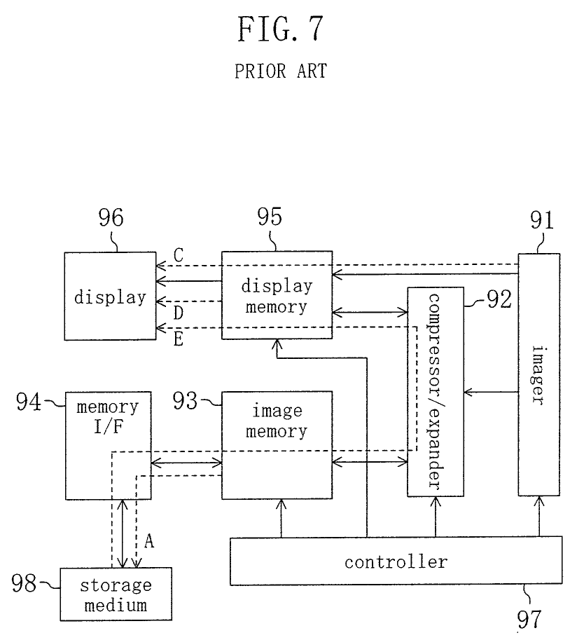

In this manner, according to the present invention, compressed image data is expanded first, and then the expanded data is presented on the display 6 while the same compressed image data is being transferred to the medium 8. In contrast, the known image processor such as that shown in FIG. 7 has to conduct the blackout or freeze display (e.g., the n^{th} image is presented continuously) while the compressed image data is being transferred to the storage medium.

The thumbnail images sequentially appear, and are added one by one, onto the same screen in the order in which their original images were captured. For example, while the compressed image data of the ninth image is being transferred, the thumbnail images TH1 through TH9 of the first through ninth images are displayed on the same screen as shown in FIG. 4D.

As described above, according to the present invention, while the image data representing a series of images captured consecutively is being transferred to a medium, the thumbnail images thereof are sequentially displayed one by one. Thus, the user can review the images without waiting until the image data representing his or her consecutive shots has been transferred completely. Also, since the image being transferred to the medium is displayed, the user can know how much data has been transferred so far. Furthermore, the thumbnail images may be displayed side by side as shown in FIG. 4 in the order in which their original images were captured. Accordingly, the user can easily check any change occurring in the images by comparing one of his or her consecutive shots to the preceding and succeeding ones of them.

In the example illustrated in FIG. 4, the nine thumbnail images TH1 through TH9 are displayed on one screen. However, any other number of thumbnail images may be displayed on one screen. If the number n of images captured consecutively is greater than the preset number m (where m is an integer equal to or greater than two) of thumbnail images that can be displayed on one screen at a time, then the number m may be increased. Alternatively, the entire screen may be cleared once and then the remaining thumbnail images may be sequentially displayed one by one from the (m+1)^{th} image.

Next, it will be described how the processor shown in FIG. 1 operates when presenting non-reduced, full-size images, not the thumbnail images.

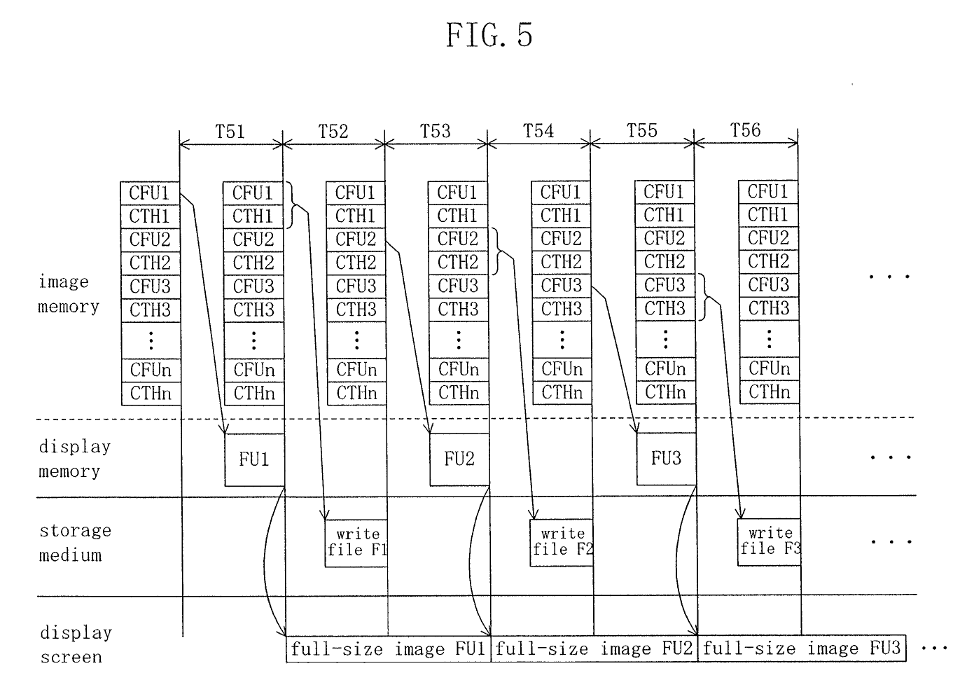

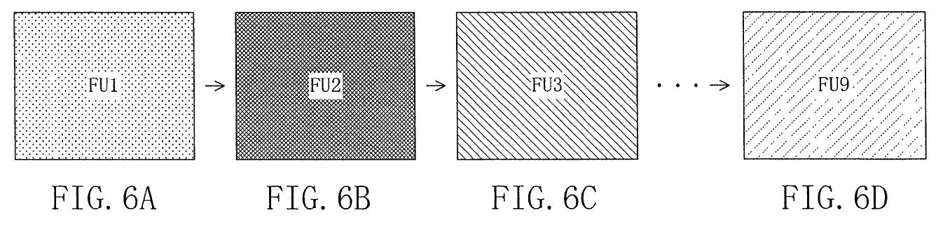

FIG. 5 is a timing diagram illustrating how the processor shown in FIG. 1 may operate when presenting full-size images. FIG. 6 illustrates how the full-size images are presented one after another on the display 6.

As shown in FIG. 5, in the interval T51 just after the images have been captured consecutively, the compressor/expander 2 reads out only the full-size compressed image data CFU1 of the first image from the image memory 3, expands the image data CFU1 to obtain a full-size image FU1 and then outputs the image FU1 to the display memory 5.

In the next interval T52, the image memory 3 transfers the full-size and thumbnail compressed image data CFU1 and CTH1 of the first image to the storage medium 8 by way of the memory interface 4. As a result, these two types of data are written as a file F1 on the storage medium 8. In the meantime, the display 6 presents the full-size image FU1 of the first image stored on the image memory 5 as shown in FIG. 6A. That is to say, the image being transferred to the storage medium 8 is presented on the display 6.

In the next interval T53, the same full-size image FU1 is still presented on the display 6. In this same interval, the compressor/expander 2 reads out only the full-size compressed image data CFU2 of the second image from the image memory 3, expands the image data CFU2 to obtain a full-size image FU2 and then outputs the image FU2 to the display memory 5. In this case, the controller 7 controls the addresses of the images FU1 and FU2 on the display memory 5 so that the full-size image FU2 is displayed instead of the full-size image FU1.

In the next interval T54, the image memory 3 transfers the full-size and thumbnail compressed image data CFU2 and CTH2 of the second image to the storage medium 8 by way of the memory interface 4. As a result, these two types of data are written as a file F2 on the storage medium 8. In the meantime, the display 6 presents the full-size image FU2 of the second image stored on the image memory 5 as shown in FIG. 6B.

In the same way, after the full-size image FU3 of the third image has been output to the display memory 5 in the interval T55, the compressed image data of the third image is transferred from the image memory 3 to the storage medium 8 and written as a file F3 on the medium 8 in the interval T56. In this interval T56, the full-size image FU3 is presented on the display 6 as shown in FIG. 6C. These operations will be repeatedly performed until the compressed image data of the n^{th} image has been written on the medium 8.

In this manner, the full-size images are displayed one after another in the order in which the images were captured. For example, while the compressed image data of the ninth image is being transferred, the full-size image FU9 of the ninth image is displayed as shown in FIG. 6D.

As described above, while the image data, representing a series of images captured consecutively, is being transferred to the storage medium, the full-size images thereof may be displayed one after another according to the present invention. Even in this situation, the user can also review the images without waiting until the image data representing his or her consecutive shots has been transferred completely. Also, since the image being transferred to the medium is displayed, the user can also know how much data has been transferred so far. Furthermore, the images are displayed one after another in the order in which the images were captured. Accordingly, the user can easily check any change occurring in the images by comparing one of his or her consecutive shots to the preceding and succeeding ones of them.

If the user has photographed a series of images of an object with little motion, then it might be difficult for him or her to perceive the change using their thumbnail versions only. In that case, it would be easier for him or her to check the change if the full-size images are displayed one after another as in the example illustrated in FIGS. 5 and 6.

In the image processor shown in FIG. 1, the image and display memories 3 and 5 are provided separately. Alternatively, the image and display memories 3 and 5 are implementable as a single memory. In that case, the image data to be temporarily stored on the image memory 3 and then transferred to the storage medium 8 may coexist in the same memory area with the image data to be stored on the display memory 5 and presented on the display 6. However, the processing would be easier if the memory area is divided into two blocks for the image data to be transferred and the image data to be displayed, respectively.

In the embodiment illustrated in FIG. 3, after the thumbnail compressed image data CTH1 has been expanded in the interval T31, the full-size and thumbnail compressed image data CFU1 and CTH1 is transferred to the storage medium 8 in the next interval T32. Alternatively, the expansion and the transfer may also be performed concurrently. Then, the overall processing time can be shortened.

Also, in the foregoing embodiment, while the image data of an image is being transferred to the medium, the same image is displayed. That is to say, the foregoing embodiment supposes that the display screen should be updated synchronously with the transfer of the image data to the medium. However, the screen does not have to be updated synchronously with the data transfer.

For example, the display update interval may be modified in such a manner as to allow the user to review the images more easily. As another alternative, the images may be displayed at shorter intervals. That is to say, before the image data of an image is transferred to the medium, the image may be displayed. Then, just by taking a look at the screen briefly, the user can determine whether or not the image data should be saved. If the answer is NO, the user can readily cancel the transfer of his or her unwanted data to the medium at once. Accordingly, no unwanted data is transferred and the time for the transfer processing can be shortened as a whole.

As another alternative, before the image data of a series of images captured consecutively starts to be transferred to the medium, these images may start to be displayed. In that case, all of those images may be displayed before the image data has been transferred to the medium completely.

As described above, according to the present invention, after a series of images have been captured consecutively and before the image data representing the images has been transferred to the storage medium completely, those images are displayed. Thus, the user can review his or her consecutive shots without having to wait a long time. In addition, according to the present invention, no freeze display or no monitor display of the imager output is conducted during the image data transfer. Consequently, the present invention eliminates the need of operating the display or the imager in vain and cuts down the power dissipation.

What is claimed is:

1. An image processor for capturing an image of an object and recording image data, representing the image, on a storage medium,
wherein while image data, representing a series of images captured consecutively, is being transferred to the storage medium, the image processor presents the series of images sequentially in an order in which the images have been captured.

2. An image processor comprising:
an imager for capturing an image of an object and outputting image data representing the image captured;
a compressor/expander, which receives and compresses the image data and then outputs the compressed image data or which receives and expands the compressed image data and then outputs the expanded image data;
an image memory for storing the compressed image data thereon;
a display memory for storing the expanded image data thereon;
a display for presenting thereon the expanded image data that has been once stored on the display memory; and
an interface for recording the compressed image data, which has been once stored on the image memory, on a storage medium,
wherein if the imager has captured a series of images consecutively,
the image memory stores compressed image data that represents the series of images captured, and
the compressor/expander expands the compressed image data, representing the series of images, and then outputs the expanded image data to the display memory so that the series of images are presented on the display sequentially in an order in which the images have been captured, while the compressed image data, representing the series of images, is being transferred from the image memory to the storage medium.

3. The processor of claim 2, wherein the compressor/expander produces a reduced-size image for each said image captured and compresses the reduced-size image to obtain and output the compressed image data, and
wherein the compressor/expander expands the compressed image data, representing the series of images, and then outputs the expanded image data to the display memory so that the reduced-size versions of the series of images can be presented one by one on the same display in the order in which the images have been captured.

4. The processor of claim 2, wherein the compressor/expander expands the compressed image data, representing each of the series of images which is being transferred to the storage medium, and then outputs the expanded image data to the display memory so that each said image being transferred can be presented on the display.
